(19) United States
(12) Patent Application Publication
(10) Pub. No.: US 2012/0296242 A1
(43) Pub. Date: Nov. 22, 2012

(54) PASSIVE EXERCISE EQUIPMENT

(76) Inventors: Kazuhiro Ochi, Osaka (JP); Takao Goto, Shiga (JP); Youichi Shinomiya, Osaka (JP); Takahisa Ozawa, Kanagawa (JP)

(21) Appl. No.: 13/522,999

(22) PCT Filed: Jan. 26, 2011
(86) PCT No.: PCT/JP2011/051400

§ 371 Date: Jul. 19, 2012

(30) Foreign Application Priority Data
Jan. 26, 2010 (JP) 2010-014805

(51) Int. Cl. A61H 1/02

(52) U.S. Cl. 601/5

(57) ABSTRACT

A drive device has a motor for generating a drive force, a power transmission unit for transmitting the force generated by the motor to first and second foot support tables, thereby moving the foot support tables, and a control unit for controlling the motor. The power transmission unit is connected to an output shaft of the motor. The power transmission unit has a left foot reciprocation mechanism for reciprocating a left foot support table, a right foot reciprocation mechanism for reciprocating a right foot support table, and a power divergence unit for diverging the force of the motor into the reciprocation mechanisms and transmitting the force thereto. The power transmission unit alternately transmits the rotation force of the motor to the left and right foot support tables, thereby causing the left and right foot support tables to alternately move in a forward and backward direction in increments of one reciprocation.

### TECHNICAL FIELD

The invention relates to a passive exercise equipment configured to regularly move foot supports on which user's feet are rested, thereby providing the user with a passive exercise.

### BACKGROUND ART

Walking movement requires persons to each put their own weight on their own pivoting feet while at the same time moving their own feet other than their own pivoting feet forward.

It is however difficult for aged persons whose athletic performance is decreased to walk because of incapable of performing the walking movement smoothly, which results in injury accidents caused by falling while walking.

There is also a possibility that even younger person cannot walk well after convalescing from his or her bone fracture or the like, i.e., nonambulatory condition for a prolonged period of time, because he or she has difficulties in a center-of-gravity shift required for walking, and coordinated movements of contraction and relaxation timing with respect to each muscle of joints, thereby resulting in stagger and off-balance.

A standing-position type passive exercise machine for ambulation exercise has been therefore suggested (see WO 2009/084577A1 (“patent document 1”)). The machine provides a possible exercise for a user with difficulty in walking by relating with each other right and left foot supports on which user's feet are rested to move them. In the passive exercise machine of the patent document 1, it is possible to provide a user with a simulated passive walking movement by moving two foot supports in a horizontal direction while alternately moving them up and down.

However, in the passive exercise machine of the patent document 1, moving the foot supports at the same time results in user's trunk swing and center-of-gravity stagger. A heavy burden is required of a user having a remarkable deterioration in balance capacity in particular, and it is accordingly difficult to do exercise continuously. A person with difficulty in walking as noted above cannot walk properly in the first place and obtain so good training effectiveness through a treadmill configured to simply provide walking movement.

### DISCLOSURE OF THE INVENTION

The present invention is provided in view of the issues described above, and an object is to provide a passive exercise equipment which enables a person with difficulty in walking to continuously perform an effective training.

The present invention is a passive exercise equipment, and comprises a first foot support on which a foot of a user is rested, and a drive unit configured to drive the first foot support. The drive unit comprises a reciprocating mechanism configured to reciprocate the first foot support between a reference position and a predetermined position behind or ahead of the reference position. (Hereinafter referred to as a “configuration 1”.)

In this configuration, the first foot support on which a foot of a user is rested is reciprocated, through the reciprocating mechanism, between the reference position and the predetermined position behind or ahead of the reference position. Accordingly, one foot of the user is passively moved back and forth. Therefore, a user's muscle group of a side of the foot rested on the first foot support receives a stimulus similar to that in walking, and a muscle group of another foot side of the user has a stimulus similar to that of a user's pivoting foot in walking. As a result, the user can perform an effective walking training. In comparison with a conventional configuration for moving user's feet at the same time, user's trunk swing can be avoided and a burden imposed on the user is decreased, thereby enabling a person with difficulty in walking to conduct an excise continuously.

In an embodiment, in addition to said first foot support on which a first foot of the user is rested, the passive exercise equipment comprises a second foot support on which a second foot of the user is rested. The drive unit is configured to drive the first and second foot supports so as to keep the second foot support at the reference position defined for the second foot support while reciprocating the first foot support, through the reciprocating mechanism, between the reference and predetermined positions defined for the first foot support. The drive unit is also configured to drive the first and second foot supports so as to keep the first foot support at the reference position defined for the first foot support while reciprocating the second foot support, through the reciprocating mechanism, between the reference and predetermined positions defined for the second foot support.

In an embodiment, the drive unit is configured to turn the second foot support so as to plantarflex or dorsiflex the second foot while keeping the second foot support at the reference position defined for the second foot support. The drive unit is also configured to turn the first foot support so as to plantarflex or dorsiflex the first foot while keeping the first foot support at the reference position defined for the first foot support.

In an embodiment, the drive unit is configured to turn the first foot support so as to plantarflex or dorsiflex the first foot while reciprocating the first foot support, through the reciprocating mechanism, between the reference and predetermined positions defined for the first foot support. The drive unit is also configured to turn the second foot support so as to plantarflex or dorsiflex the second foot while reciprocating the second foot support, through the reciprocating mechanism, between the reference and predetermined positions defined for the second foot support.

In an embodiment, the drive unit is configured to drive the first and second foot supports so as to reciprocate the user's first and second feet in a front-back direction of the user through the reciprocating mechanism, respectively. Each reference position of the first and second foot supports is a back-end of its own reciprocation path. Each predetermined position of the first and second foot supports is a front-end of its own reciprocation path.

In an embodiment, the drive unit is configured to drive the first and second foot supports so as to reciprocate the user's first and second feet in a front-back direction of the user through the reciprocating mechanism, respectively. Each reference position of the first and second foot supports is a front-end of its own reciprocation path. Each predetermined position of the first and second foot supports is a back-end of its own reciprocation path.

In an embodiment (e.g., the configuration 1), a position of the first foot support, when the user takes a posture in which positions in a front-back direction of the user's feet are aligned, is defined as the reference position. (Hereinafter referred to as a “configuration 2”.)

In an embodiment (but not limited to, e.g., the configuration 2), the drive unit comprises a first turning mechanism configured to turn the first foot support around a turning axis along a horizontal plane. The first turning mechanism is configured, during one back-and-forth motion of the first foot support between the reference and predetermined positions, to turn the first foot support from a basic posture in which an upper face of the first foot support is horizontal to a plantarflexion posture in which a side of a user's toe is turned downward, and then to return it to the basic posture. This configurations is hereinafter referred to as a “configuration 3”.

This configuration enables a user to plantarfiex the foot rested on the first foot support, and induces exercise of muscle groups of user's legs and lower back by reflex of user's nerve system for maintaining balance in order to avoid falling. The user receives a force by which a user's heel other than the pivoting foot is pushed up with a foot support, and maintains the user's posture in the teeth of the force, thereby contracting a muscle group of a user's shank. It is therefore possible to get more effective walking training because the muscle group of the shank is in a state similar to that at a heel contact timing during a shift from a swing phase to a contact phase in walking, and receives a stimulus similar to that in actual walking.

In an embodiment (e.g., the configuration 2), the drive unit comprises a first turning mechanism configured to turn the first foot support around a turning axis along a horizontal plane. The first turning mechanism is configured, during one back-and-forth motion of the first foot support between the reference and predetermined positions, to turn the first foot support from a basic posture in which an upper face of the first foot support is horizontal to a dorsiflexion posture in which a side of a user's toe is turned upward, and then to return it to the basic posture. This configuration is hereinafter referred to as a “configuration 4”.

This configuration enables a user to dorsiflex the user's foot rested on the first foot support, and induces exercise of muscle groups of user's legs and lower back by reflex of user's nerve system for maintaining balance in order to avoid falling.

In an embodiment (e.g. any of the configurations 2-4), a passive exercise equipment comprises a second foot support on which a user's foot other than the foot rested on the first foot support is rested. The second foot support is also driven through the drive unit. This configuration is hereinafter referred to as a “configuration 5”.

In an embodiment (e.g., the configuration 5), the drive unit is configured, while the reciprocating mechanism reciprocates the first foot support, to restrain a position of the second foot support in a horizontal plane to a position that the user takes a posture in which positions in a front-back direction of the user's feet are aligned when the first foot support is at the reference position. (Hereinafter referred to as a “configuration 6”.)

In this configuration, when the first foot support is reciprocated, a user is to shift the user's weight to a side of a user's pivoting foot that is the foot at a side of the second foot support and restrained at a fixed position. Thereby, the user can passively conduct action for putting the user's weight on the pivoting foot, and action for moving a user's foot other than the pivoting foot forward, which are required for walking movement.

In an embodiment (e.g., the configuration 6), the drive unit comprises a second turning mechanism configured to turn the second foot support around a turning axis along a horizontal plane. The second turning mechanism is configured, during one back-and-forth motion of the first foot support between the reference and predetermined positions, to turn the second foot support from a basic posture in which an upper face of the second foot support is horizontal to a dorsiflexion posture in which a side of a user's toe is turned upward, respectively, and then to return it to the basic posture. This configuration is hereinafter referred to as a “configuration 7”.

This configuration enables a user to dorsiflex the user's foot rested on the second foot support, and induces exercise of muscle groups of user's legs and lower back by reflex of user's nerve system for maintaining balance in order to avoid falling. The user receives a force by which a toe of a user's pivoting foot is pushed up with a foot support and maintains the user's posture in the teeth of the force, thereby contracting a muscle group of a user's calf. It is therefore possible to get more effective walking training because the muscle group of the calf is in a state similar to that at a stepping forward timing during a shift from a contact phase to a swing phase in walking, and receives a stimulus similar to that in actual walking.

In an embodiment (e.g., the configuration 6), the drive unit comprises a second turning mechanism configured to turn the second foot support around a turning axis along a horizontal plane. The second turning mechanism is configured, during one back-and-forth motion of the first foot support between the reference and predetermined positions, to turn the second foot support from a basic posture in which an upper face of the second foot support is horizontal to a plantarflexion posture in which a side of a user's toe is turned downward, and then to return it to the basic posture. This configuration is hereinafter referred to as a “configuration 8”.

This configuration enables a user to plantarflex the user's foot rested on the second foot support, and induces exercise of muscle groups of user's legs and lower back by reflex of user's nerve system for maintaining balance in order to avoid falling.

In an embodiment (any of the configurations 5-8), the drive unit is configured to switch between a first state and a second state whenever the first foot support returns to the reference position after one back-and-forth motion. In the first state, one of the foot support on which the user's right foot is rested and the foot support on which the user's left foot is rested is treated as the first foot support, while the other is treated as the second support. In the second state, the first foot support and the second foot support are interchanged from the first state between the foot support on which the right foot is rested and the foot support on which the left foot is rested.

In this configuration, a user can alternately reciprocate the user's feet every one back-and-forth motion, and receives well-balanced stimulus on the user's feet and can do a training best suited to actual walking.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is a schematic diagram showing a configuration in accordance with an embodiment 1 of the present invention;

FIG. 2 is a schematic plain view of the configuration;

FIG. 3 is a schematic perspective view of the essential parts of the configuration;

FIG. 4 is an operational explanatory diagram of the embodiment;

FIGS. 5A-5C are schematic side views showing the operations;

FIG. 6 is a schematic front view showing other configuration;

FIG. 7 is a schematic diagram showing a configuration in accordance with an embodiment 2 of the present invention;

FIGS. 8A and 8B illustrate the configuration, and FIG. 8A is a schematic plain view and FIG. 8C is a schematic side view;

FIGS. 9A and 9B are operational explanatory diagrams of the embodiment;

FIGS. 10A-10C are schematic side views showing operations of the embodiment;

FIG. 11 is a schematic side view showing the essential parts of an embodiment 3 of the present invention;

FIGS. 12A and 12B are operational explanatory diagrams of the embodiment;

FIGS. 13A-13C are schematic side views showing operations of the embodiment;

FIGS. 14A-14D are schematic side views showing other configurations of the embodiment; and

FIGS. 15A and 15B are schematic side views showing operations of the embodiment.

### BEST MODE FOR CARRYING OUT THE INVENTION

### Embodiment 1

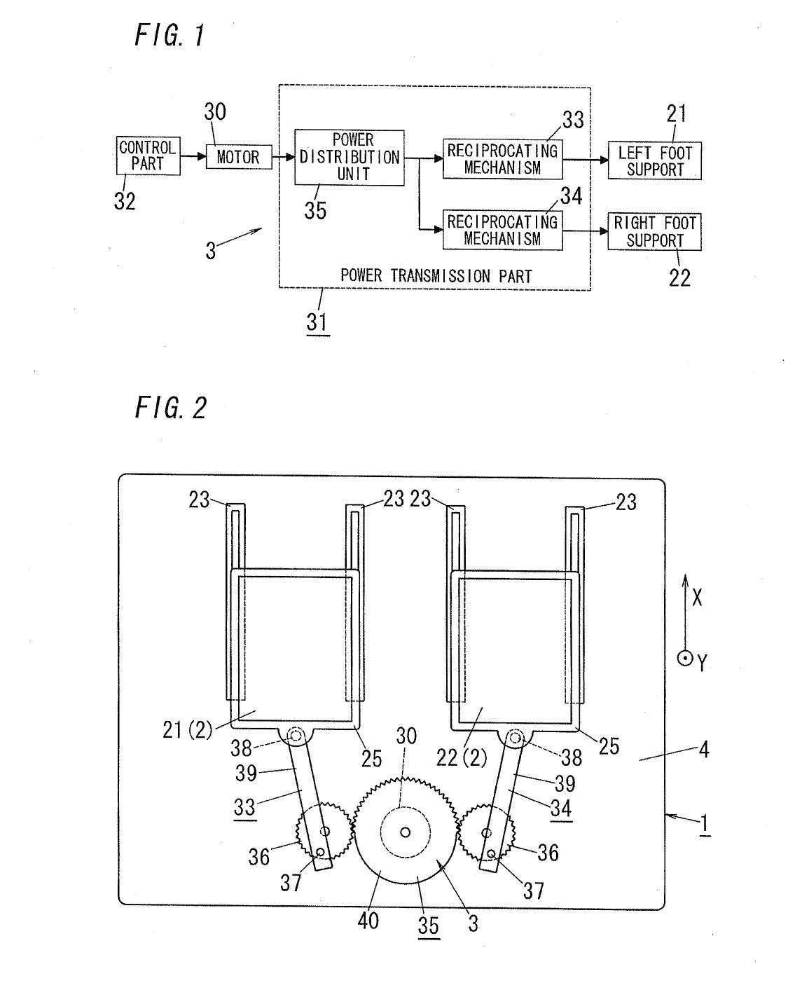

As shown in FIG. 2, a passive exercise equipment 1 of the embodiment has, on the base 4, left and right foot supports 21 and 22 on which user's left and right feet are rested, respectively, (hereinafter simply referred to as “foot supports 2” when they are not distinguished in particular) and a drive unit 3 configured to drive the foot supports 2. The base 4 is in the shape of a rectangle and forms, together with a cover (not shown), a housing in which the drive unit 3 is put.

The passive exercise equipment 1 is explained. In this embodiment, the equipment is used in a state that a user stands on the base 4 put on a floor to rest the user's left and right feet on the left and right foot supports 21 and 22, respectively (a standing position). The upper and lower sides of the passive exercise equipment 1 put on the floor are hereinafter referred to as an up-and-down direction, and an array direction of the left and right foot supports 21 and 22 are referred to as a lateral direction, and a direction of an arrow X in FIG. 2 is referred to as a front direction. That is, back-and-forth and left-and-right to be hereinafter described coincide with back-and-forth and left-and-right of a user standing on the passive exercise equipment 1.

As shown in FIG. 1, the drive unit 3 has a motor 30, namely a drive source configured to generate a drive force, a power (motive energy) transmission part 31 configured to transmit a drive force generated with the motor 30 to the foot supports 2 to move the foot supports 2, and a control part 32 configured to control the motor 30. In the embodiment, a geared motor (a motor with reduction gears) capable of high torque output is employed as the motor 30.

In the embodiment, the motor 30 is fixed to the base 4 so that its output axis is placed along an up-and-down direction, and the output axis is coupled with the power transmission part 31. The power transmission part 31 has a left foot reciprocating mechanism 33 configured to reciprocate the left foot support 21, a right foot reciprocating mechanism 34 configured to reciprocate the right foot support 22, and a power distribution unit 35 configured to divide and transmit a drive force of the motor 30 to the reciprocating mechanisms 33 and 34.

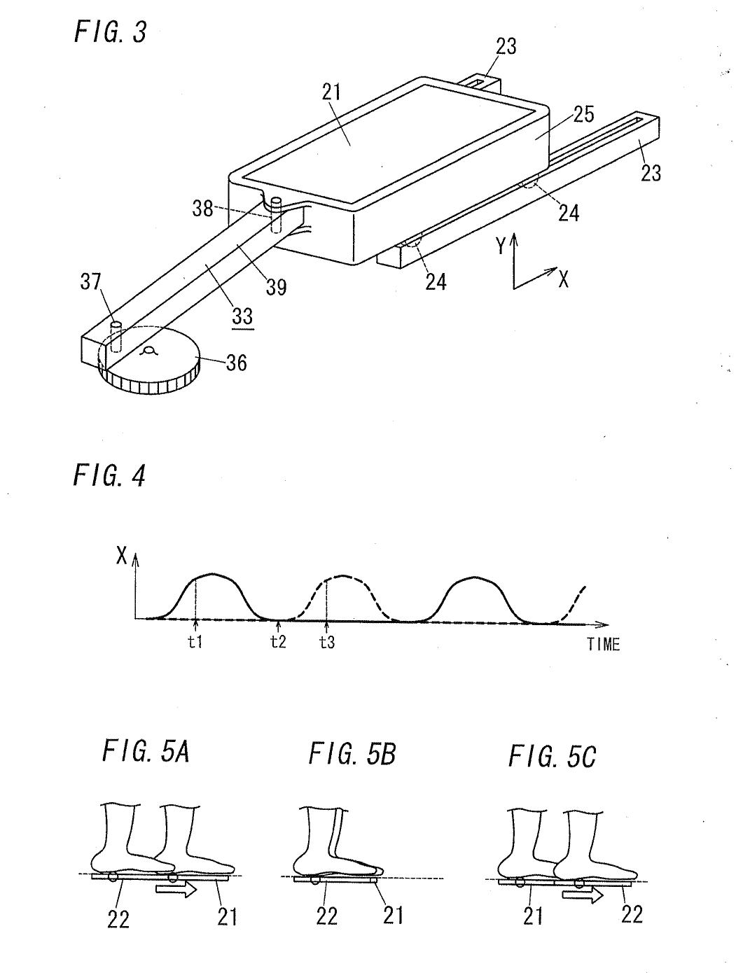

Specifically, as shown in FIG. 3, rails 23 extended in a front-back direction are arranged at both sides of each foot support 2 in the lateral direction respectively in order to regulate its own moving path so that each foot support 2 is capable of reciprocating in the front-back direction. Each foot support 2 is in the shape of a rectangle and placed in an opening of a rectangular frame 25 having wheels 24 capable of rolling on the rails 23. In the embodiment, each foot support 2 and a corresponding frame 25 are united, and each foot support 2 moves in the front-back direction along with a corresponding frame 25 if a drive force of the motor 30 is transmitted to each frame 25 through the power transmission part 31. FIG. 3 shows the left, foot support 21, but the right foot support 22 has a like configuration.

Each foot support 2 is in the shape of a rectangle extending in the front-back direction in a planer view, and has a size corresponding to a user's foot (the whole sole). The passive exercise equipment 1 is used in a state that user's left and right feet are rested on the left and right foot supports 2, respectively. In the embodiment, a shape or material with a large friction coefficient is used for surfaces (upper faces) of the foot supports 2, thereby preventing the slip of user's feet rested on the foot supports 2.

The power distribution unit 35 has a half-toothed wheel 40 fixed to the output axis of the motor 30, and left and right spur wheels 36 engaging with the half-toothed wheel 40. The half-toothed wheel 40 has teeth formed at substantially a half circumference of a disk-shaped member, and each teeth number of the half-toothed wheel 40 and the two spur wheels 36 is set so that a spur wheel 36 goes into a 360-degree roll while the half-toothed wheel 40 goes into a 180-degree roll. Therefore, if the motor 30 is driven, one of the spur wheels 36 is rotated one turn while the other runs idle, whenever the half-toothed wheel 40 is rotated a half-turn. The left and right spur wheels 36 are alternately rotated one turn by one turn.

In the embodiment, each turning force of the spur wheels 36 is converted into a reciprocating movement of a corresponding foot support 2 through a corresponding reciprocating mechanism 33 or 34 with a slider crank mechanism. Each of the reciprocating mechanisms 33 and 34 is combined with corresponding foot support 2, frame 25 and spur wheel 36. That is, the reciprocating mechanism 33 is combined with the left foot support 21, a left foot frame 25 and a left foot spur wheel 36, while the reciprocating mechanism 34 is combined with the right foot support 22, a right foot frame 25 and a right foot spur wheel 36. More specifically, each of the reciprocating mechanisms 33 and 34 has a first pin 37 placed at an outer circumference side of an upper face of a corresponding spur wheel 36, a second pin 38 placed at a back-end of a corresponding frame 25, and a crank connecting rod 39 connecting the first and second pins 37 and 38. Both ends of the crank connecting rod 39 are pivotally supported by the first and second pins 37 and 38 in a horizontal plane. Each frame 25 is regulated so that its own moving direction becomes a front-back direction through two rails 23 as noted above, and consequently a turning force of its own spur wheel 36 is converted into a force for reciprocating its own foot support 2 in the front-back direction. The left and right reciprocating mechanisms 33 and 34 have a bilaterally symmetric configuration.

In the aforementioned configuration, the power transmission part 31 alternately transmits a turning force of the motor 30 to the left and right foot supports 21 and 22, thereby alternately moving the left and right foot supports 21 and 22 in a front-back direction one back-and-forth motion by one back-and-forth motion. In this case, each foot support 2 alternately reciprocates between a reference position and a predetermined position set ahead of the reference position (a front-end of a movable scope), where the reference position is a position that the left and right foot supports 21 and 22 are arranged side by side in a lateral direction.

That is, when the motor 30 is rotated in one direction, each foot support 2 is moved so that its own position in a front-back direction periodically changes between its own reference and predetermined positions, as shown in FIGS. 4 and 5. In FIG. 4, the abscissa axis is a temporal axis, and the ordinate axis represents a distance X in a front direction from a reference position (X=0) of each foot support 2, and the solid and dash lines represent movement of the left and right foot supports 21 and 22, respectively.

That is, the drive unit 3 first moves the left foot support 21 from the reference position to the predetermined position ahead of the reference position with the right foot support 22 restrained at the reference position. Therefore, at time point t1 of FIG. 4, the left foot support 21 moves more forward than the right foot support 22 as shown in FIG. 5A. If the left foot support 21 moves to the front-end of the movable scope (the predetermined position), the drive unit 3 moves the left foot support 21 backward to return it to the reference position. Accordingly, at time point t2 of FIG. 4, the positions of the left and right foot supports 21 and 22 in a front back direction are accorded as shown in FIG. 5B. Therefore, a user of the passive exercise equipment 1 once moves the user's left foot forward with the user's right foot as a pivoting foot restrained at the reference position, and then returns it to the original reference position.

If the left foot support 21 is returned to the reference position, the drive unit 3 next moves the right foot support 22 from the reference position to the predetermined position ahead of the reference position with the left foot support 21 restrained at the reference position. Therefore, at time point t3 of FIG. 4, the right foot support 22 moves more forward than the left foot support 21 as shown in FIG. 5C. If the right foot support 22 moves to the front-end of the movable scope (the predetermined position), the drive unit 3 moves the right foot support 22 backward to return it to the reference position. Therefore, the user once moves the user's right foot forward with the user's left foot as a pivoting foot restrained at the reference position, and then returns it to the original reference position. Subsequently, the drive unit 3 alternately reciprocates the left and right foot supports 2 in the front-back direction, and the user thereby repeats, alternately with respect to the user's left and right feet, action for moving user's any foot forward to return it to the original position.

In the left and right foot supports 21 and 22, a foot support 2 reciprocating between the reference and predetermined positions and a foot support 2 restrained at the reference position in a horizontal plane are hereinafter also referred to as a “first foot support 2” and a “second foot support 2”, respectively. That is, in the embodiment, whenever the first foot support 2 returns to the reference position after one back-and-forth motion, the drive unit 3 interchanges the first and second foot supports 2 between the left and right foot supports 21 and 22. In other words, the drive unit 3 is configured to alternately switch between a first state and a second state. In the first state, the left foot support 21 is treated as the first foot support 2, while the right foot support 22 is treated as the second foot support 2. In the second state, the right foot support 22 is treated as the first foot support 2, while the left foot support 21 is treated as the second foot support 2. Incidentally, a path from the reference position to the predetermined position and a path from the predetermined position to the reference position constitute one back-and-forth path.

A first foot support of the present invention is not limited to a foot support reciprocating between the reference and predetermined positions. Similarly, a second foot support of the present invention is not limited to a foot support restrained at the reference position in a horizontal plane. For example, in one configuration example of the present invention (hereinafter referred to as a “configuration A”), the drive unit 3 is configured to drive the first and second foot supports so as to keep the second foot support (22 or 21) at the reference position defined for the second foot support while reciprocating the first foot support (21 or 22), through the reciprocating mechanism (33 or 34), between the reference and predetermined positions defined for the first foot support. The drive unit 3 is configured to drive the first and second foot supports so as to keep the first foot support at the reference position defined for the first foot support while reciprocating the second foot support, through the reciprocating mechanism, between the reference and predetermined positions defined for the second foot support. In the example of FIG. 2, the drive unit is configured to drive the first and second foot supports so as to reciprocate user's first and second feet in a front-back direction of the user through the reciprocating mechanisms. A reference position of each of the first and second foot supports is a back-end of its own reciprocating path, while a predetermined position of each of the first and second foot supports is a front-end of its own reciprocating path. Specifically, the reciprocating paths have the same length, and the front-ends are arranged in parallel with (in the proximity of) a front edge of the base 4. However, not limited to this, in each of the first and second foot supports of the present invention, reference and predetermined positions may be front and back ends of its own reciprocating path, respectively.

Since a user passively moves one of the user's feet forward by using the passive exercise equipment 1, the user inevitably shifts the user's weight to user's other foot as a pivoting foot restrained at the reference position. Accordingly, the user can passively conduct action for putting the user's weight on a user's pivoting foot and action for moving a user's foot other than the pivoting foot forward, which are required for walking movement. In other words, the passive exercise equipment 1 enables a user to conduct a fundamental training required for walking by providing a stimulus for muscle groups required for walking.

Moreover, the passive exercise equipment 1 not reciprocates both foot supports 2 at the same time in a front-back direction, but reciprocates the left and right foot supports 2 one by one in a front-back direction. Accordingly, exercise with a heavy burden caused by user's trunk swing can be avoided. Therefore, it is possible to provide continuous excise through the passive exercise equipment 1 for aged persons whose athletic performance is decreased, or persons with difficulty in walking due to nonambulatory condition for a prolonged period of time for convalescing from their bone fracture.

By using the passive exercise equipment 1 in the embodiment, even persons with difficulty in walking described above can continuously perform exercise from a fundamental action for putting their own weight on their own pivoting foot or the like. Accordingly, it is possible provide ambulation exercise promising a high effect in comparison with simulated walking movement. That is, a user can conduct exercise reasonably from a fundamental action required for walking, and conduct exercise efficiently without compulsion of exercise with a heavy burden. Since the left and right foot supports 2 alternately reciprocate every back-and-forth motion, a user receives well-balanced stimulus on the user's feet and can do a training best suited to actual walking.

The configuration of the power transmission part 31 in the embodiment is just one example, and different mechanisms can be applied to the power transmission part 31.

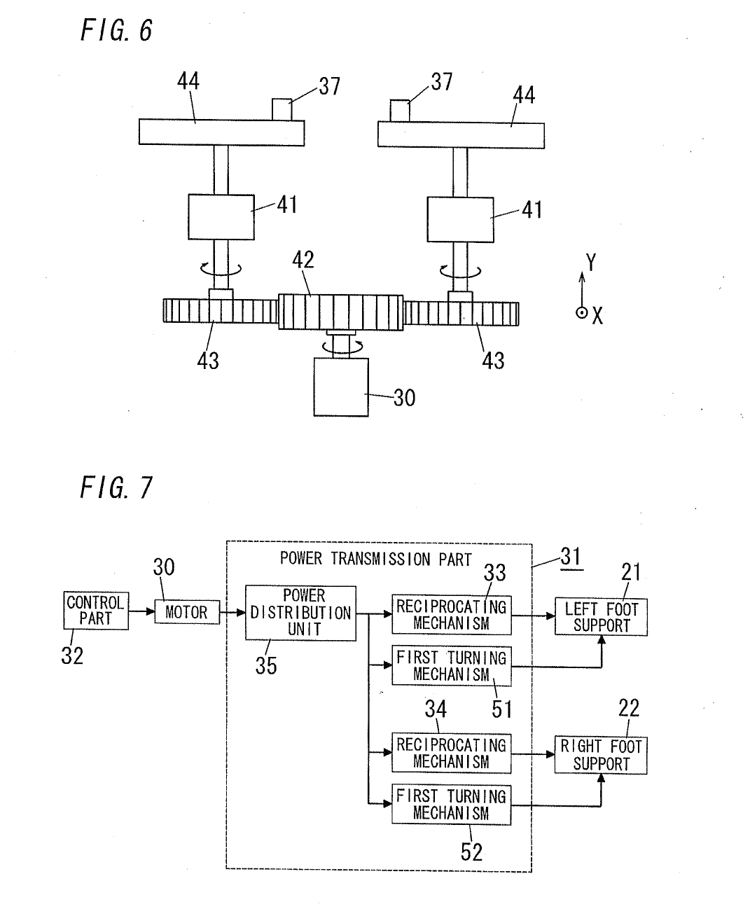

For example, as shown in FIG. 6, electromagnetic clutches 41 are used for the power distribution unit 35, each of which is configured to switch between coupling and release states that transmits and non-transmits a torque in response to a voltage applied from the control part 32, respectively. In this configuration, a drive force of the motor 30 is alternately transmitted to the left and right foot supports 2. In the example of FIG. 6, the power distribution unit 35 has a first spur wheel 42 fixed to the output axis of the motor 30 and left and right second spur wheels 43 engaging the first spur wheel 42, in place of the half-toothed wheel 40 and the two spur wheels 43 in FIG. 2. The second spur wheels 43 are connected with disks 44 through the electromagnetic clutches 41, respectively. First pins 37 by which the crank connecting rods 39 are pivotally supported are placed at outer circumference sides of upper faces of the disks 44, respectively. Rotation of the disks 44 are converted into reciprocating movement of the foot supports 2 through the reciprocating mechanisms 33 and 34, respectively.

In the aforementioned configuration, when an electromagnetic clutch 41 is in the coupling state, a turning force of the motor 30 is transmitted to a corresponding disk 44 through the electromagnetic clutch 41, and a foot support 2 reciprocates in a front-back direction in response to the rotation of the disk 44. On the other hand, when the electromagnetic clutch 41 is in the release state, the foot support 2 is stopped, because a turning force of the motor 30 is not transmitted to the disk 44. Since the left and right foot supports 2 are provided with the electromagnetic clutches 41, respectively each operation of the foot supports 2 can be controlled individually by controlling each voltage applied to the electromagnetic clutches 41 through the control part 32. That is, if the electromagnetic clutches 41 are alternately applied with voltages, the first and second foot supports 2 and 2 can be interchanged between the left and right foot supports 21 and 22 every back-and-forth motion of the first foot support 2 between the reference and predetermined positions, like the aforementioned embodiment.

In another example, the power distribution unit 35 includes cams (not shown). Even in this configuration, operation like the aforementioned embodiments can be realized. For example, cams are used in place of the spur wheels 36 in FIG. 2, and a semicircular cam is used in place of the half-toothed wheel 40. The shapes of the cams are designed so that one of the cams is rotated one turn while the other runs idle, whenever the semicircular cam is rotated a half-turn. Thereby, the left and right cams are alternately rotated one turn by one turn. Therefore, the first and second foot supports 2 and 2 can be interchanged between the left and right foot supports 21 and 22 every back-and-forth motion of the first foot support 2 between the reference and predetermined positions, like the aforementioned embodiment.

Each of the aforementioned embodiments shows an example that left and right foot supports 21 and 22 reciprocate between reference and predetermined positions in a front-back direction, but is not limited to the example. The moving paths of the left and right foot supports 21 and 22 can be set arbitrarily.

For example, the moving paths of the left and right foot supports 21 and 22 may be a V-shape totally opened forward, of which distance between front-ends in a lateral direction are wider than that between the back-ends. In this case, it is preferable that the left and right foot supports 21 and 22 are placed at a slant with respect to a straight line along a front-back direction so that the left and right foot supports 21 and 22 becomes wider toward their front sides in a horizontal plane and a user can be in a natural standing posture with the user's toes a little bit opened.

In addition, predetermined positions may be set behind reference positions, respectively. In this case, the left and right foot supports 21 and 22 are moved backward from the reference positions, and thereby reciprocate between the reference and predetermined positions. The left and right foot supports 21 and 22 may be moved in only a lateral direction.

### Embodiment 2

A passive exercise equipment 1 of the embodiment differs from the passive exercise equipment 1 of the embodiment 1 in that a second foot support 2, as a pivoting foot side, restrained at a reference position in a horizontal plane is dorsiflexed. A posture of the second foot support 2 of which upper face is horizontal is hereinafter referred to as a basic posture. A posture of the second foot support 2 that user's toe side is turned upward from the basic posture is hereinafter referred to as a dorsiflexion posture.

In the embodiment, as shown in FIG. 7, the drive unit 3 has a first turning mechanism for left foot 51 configured to dorsiflex the left foot support 21 by motive energy distributed through the power distribution unit 35, and a first turning mechanism for right foot 52 configured to dorsiflex the right foot support 22.

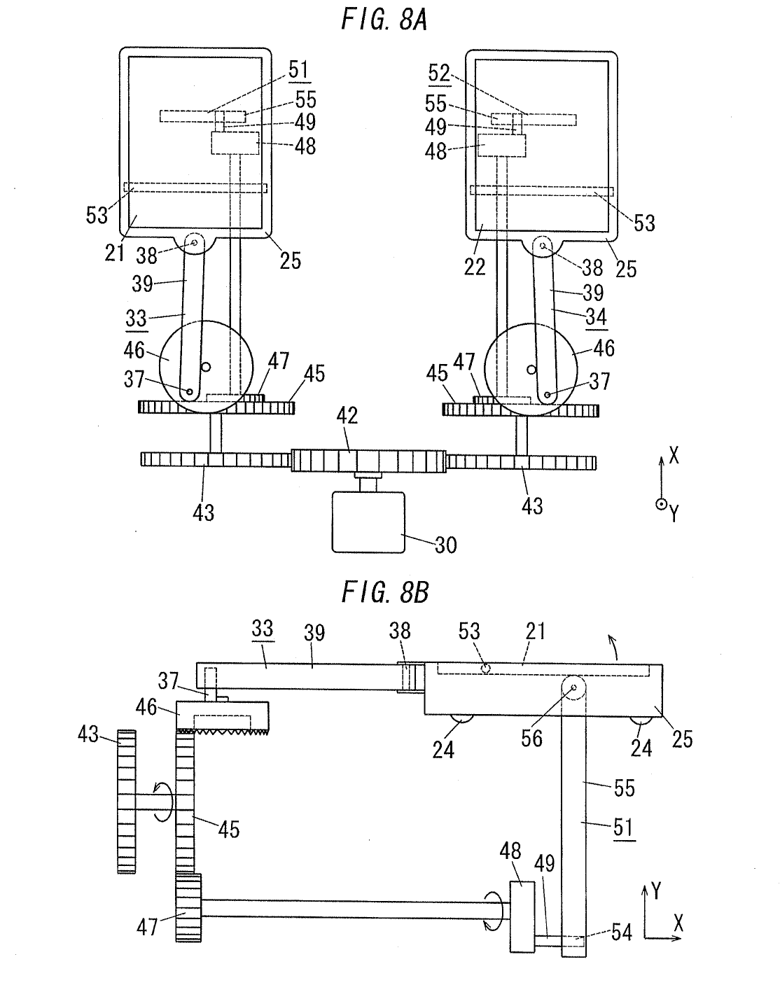

Each foot support 2 is swingably supported by a corresponding frame 25. Specifically, as shown in FIG. 8, the two foot supports 2 have two pivot axes 53 penetrating in width direction (a lateral direction), respectively. Both ends of each pivot axis 53 are pivotally supported by a corresponding frame 25. Thereby, the two foot supports 2 can swing with respect to the two frames 25 so that user's toe sides are turned upward and downward around the two pivot axes 53, respectively. Each pivot axis 53 is placed substantially immediately beneath a user's heel in a corresponding foot support 2.

In the example of FIGS. 8A and 8B, the output axis of the motor 3 is placed in a front-back direction, and the first spur wheel 42 is fixed to the output axis of the motor 30. Left and right second spur wheels 43 are further placed so as to engage with the first spur wheel 42. Each second spur wheel 43 is coupled with a half-toothed wheel 45 capable of rotating around an axis along a front-back direction. Each half-toothed wheel 45 has teeth formed at substantially a half circumference of a disk-shaped member.

The power distribution unit 35 distributes a turning force of the motor 30 to sides of the left and right foot supports 21 and 22 through the first spur wheel 42, second spur wheels 43 and the half-toothed wheels 45.

The power distribution unit 35 includes: two crown gears 46 configured to rotate around axes along an up-and-down direction and engage with the two half-toothed wheels 45, respectively; and two third spur wheels 47 configured to rotate around axes along a front-back direction and engage with the two half-toothed wheels 45, respectively. Each crown gear 46 is placed on a corresponding half-toothed wheel 45, of which teeth formed on the outer circumference of its lower face engage with the teeth of the half-toothed wheel 45. Each crown gear 46 has a first pin 37, at an outer circumference side of its own upper face, by which a crank connecting rod 39 is pivotally supported. Rotation of the two crown gears 46 is converted to reciprocating movement of the two foot supports 2 through the reciprocating mechanism 33 and 34, respectively. Each teeth number of the crown gears 46 and the half-toothed wheels 45 is set so that each crown gear 46 is rotated one turn while a corresponding half-toothed wheel 45 is rotated a half-turn. The rotational phase difference between the left and right half-toothed wheels 45 is 180 degrees, and the left and right reciprocating mechanisms 33 and 34 alternately reciprocate the left and right foot supports 2.

Each third spur wheel 47 is located under a corresponding half-toothed wheel 45, and each teeth number of the third spur wheels 47 and the half-toothed wheels 45 is set so that each third spur wheel 47 is rotated one turn while a corresponding half-toothed wheel 45 is rotated a half-turn. Therefore, if the motor 30 rotates and the second spur wheels 43 are rotated, the crown gears 46 and the third spur wheels 47 are alternately rotated one turn by one turn while the second spur wheels 43 are rotated a half-turn.

The left and right first turning mechanisms 51 and 52 have left and right disks 48 capable of rotating around axes along the front-back direction, respectively. Each disk 48 has a third pin 49, extending forward, at an outer circumference side of its own front face (an opposite surface of the disk 48 from a corresponding third spur wheel 47). Each of the first turning mechanisms 51 and 52 is provided with a cam plate 55 that is movable only in the up-and-down direction and has a guide hole 54 through which a third pin 49 is inserted.

In this configuration, if a disc 48 is rotated along with a third spur wheel 47, a cam plate 55 reciprocates in an up-and-down direction through a third pin 49, and moves one back-and-forth in an up-and-down direction while the disc 48 is rotated one turn. An upper end of the cam plate 55 is in contact with a rear face (a lower surface) of a corresponding foot support 2 ahead of the pivot axis 53, by which a foot support 2 is supported from downward. Therefore, if the cam plate 55 moves up and down, the foot support 2 having a pivot axis 53 as a center moves a user's toe side upward and downward.

In the embodiment, a positional relation between a cam plate 55 and a foot support 2 is set so that the foot support 2 is in the basic posture when the cam plate 55 is positioned at a lower end of its movable scope. The foot support 2 is turned in a direction for turning a user's toe side upward as the cam plate 55 moves upward.

As a result, while the right support 22 as the first foot support 2 moves one back-and-forth in a front-back direction, the left foot support 21 as the second foot support 2 is rotated through the first turning mechanism for left foot 51 to change from the basic posture to the dorsiflexion posture, and is then rotated in an inverse direction to return to the basic posture. On the other hand, while the left support 21 as the first foot support 2 moves one back-and-forth in a front-back direction, the right foot support 22 as the second foot support 2 is rotated through the first turning mechanism for right foot 52 to change from the basic posture to the dorsiflexion posture, and is then rotated in an inverse direction to return to the basic posture. Each cam plate 55 has a roller 56 at its own upper end, thereby decreasing the friction between the cam plate 55 and the corresponding foot support 2 while the foot support 2 reciprocates in a front-back direction.

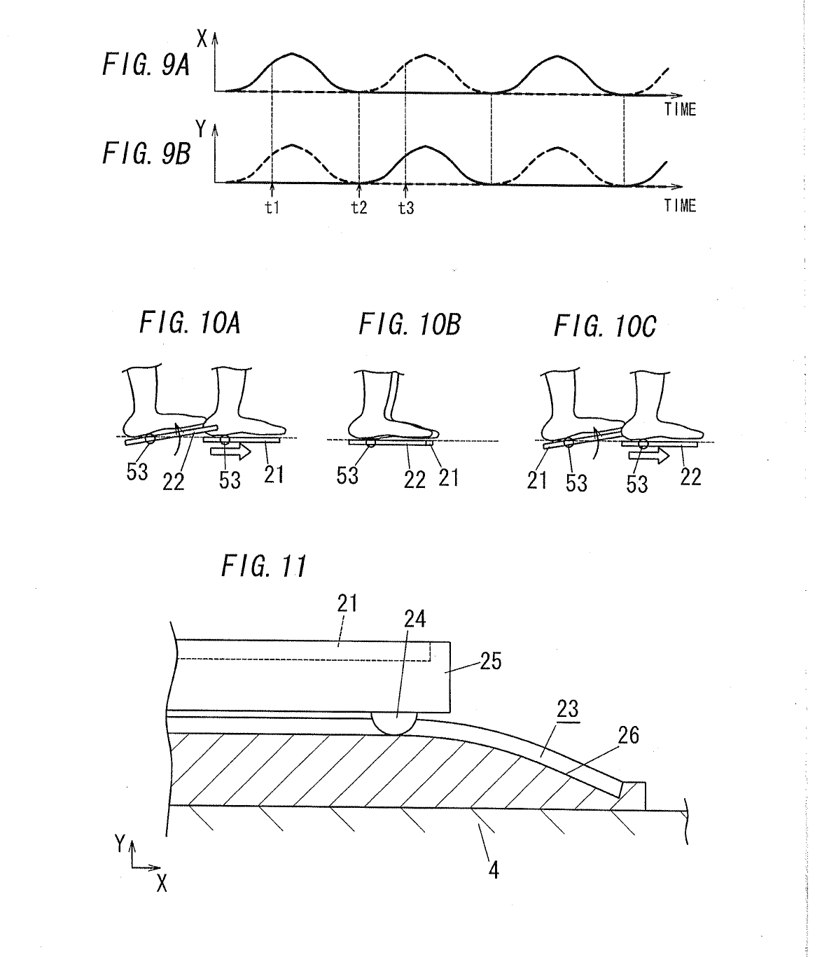

That is, a position and posture of each foot support 2 periodically change as shown in FIGS. 9 and 10. In FIG. 9, the abscissa axis is a temporal axis. In FIG. 9A, the ordinate axis represents a distance X in a front direction from a reference position (X=0) of each foot support 2. In FIG. 9B, the ordinate axis represents a distance Y in an upper direction from a basic posture (Y=0) of each foot support's (2) front-end. The solid and dash lines represent movement of the left, and right foot supports 21 and 22, respectively.

That is, the drive unit 3 first moves the left foot support 21 from the reference position to the predetermined position ahead of the reference position with the right foot support 22 restrained at the reference position, while turning the right foot support 22 in a direction that a user's toe side is turned upward. Accordingly, at time point t1 of FIG. 9, the left foot support 21 moves more forward than the right foot support 22 as shown in FIG. 10A, while the right foot support 22 is in the dorsiflexion posture. If the left foot support 21 moves to the front-end of the movable scope (the predetermined position), the drive unit 3 moves the left foot support 21 backward to return it to the reference position, while turning the right foot support 22 to return it to the basic posture. Therefore, at time point t2 of FIG. 9, the positions of the left and right foot supports 21 and 22 in a front-back direction are accorded as shown in FIG. 10B, and the foot supports 2 become in the basic posture.

If the left foot support 21 returns to the reference position, the drive unit 3 next moves the right foot support 22 from the reference position to the predetermined position ahead of the reference position with the right foot support 21 restrained at the reference position, while turning the left foot support 21 in a direction that a user's toe side is turned upward. Therefore, at time point t3 of FIG. 9, the right foot support 22 moves more forward than the left foot support 21 as shown in FIG. 10C, while the left foot support 21 is in the dorsiflexion posture. If the right foot support 22 moves to the front-end of the movable scope (the predetermined position), the drive unit 3 moves the right foot support 22 backward to return it to the reference position, while turning the left foot support 21 to return it to the basic posture.

As presented above, in the passive exercise equipment 1 of the embodiment, a user can conduct a dorsiflexion exercise of an ankle joint of a user's pivoting foot. Thus, turning a foot support 2 to dorsiflex the ankle joint induces exercise of muscle groups of user's legs and lower back by reflex of user's nerve system for maintaining balance in order to avoid falling.

If the foot support 2 of a user's pivoting foot (i.e., the second foot support) is in a dorsiflexion state, a user receives a force by which the toe of a user's pivoting foot is pushed up through the foot support 2 and maintains the user's posture in the teeth of the force, thereby contracting a muscle group of a user's calf (gastrocnemial muscle and the like). The muscle group of the calf is in a state similar to that at a stepping forward timing during a shift from a contact phase to a swing phase in walking, and receives a stimulus similar to that in actual walking.

The embodiment shows an example that the first turning mechanism 51 and 52 dorsiflex the second foot support 2, but may be a configuration that the second foot support 2 is plantarflexed. In this case, a positional relation between the cam plates 55 and the foot supports 2 is set so that the foot support 2 is in the basic posture when the cam plate 55 is positioned at an upper end of its movable scope. Thereby, when the cam plate 55 is positioned at the upper end of the movable scope, the foot support 2 is supported by the cam plate 55 to be approximately horizontal. From the state, the cam plate 55 moves downward and the foot support is turned in a direction that a user's toe side is turned downward.

The concrete configuration of the power distribution unit 35 is not limited to the aforementioned examples. The electromagnetic clutches, cams and the like in the embodiment 1 can be applied to the power distribution unit 35. For example, electromagnetic clutches may be used for transmitting and non-transmitting a drive force of the motor 30 to the crown gears 46 and the third spur wheels 47, in place of the combination of the half-toothed wheels 45 with respect to the crown gears 46 and the third spur wheels 47. In this case, the electromagnetic clutches can arbitrarily control the timing for plantarflexing and dorsiflexing each of the left and right foot supports 2.

Other configurations and functions are the same as those of the embodiment 1.

In other words, in the aforementioned configuration A, the drive unit 3 is configured to turn the second foot support so that the second foot is plantarflexed or dorsiflexed while the second foot support (22 or 21) is kept at the reference position defined for the second foot support. The drive unit 3 is also configured to turn the first foot support so that the first foot is plantarflexed or dorsiflexed while the first foot support (21 or 22) is kept at the reference position defined for the first foot support. This configuration is hereinafter referred to as a “configuration B”.

### Embodiment 3

A passive exercise equipment 1 of the embodiment differs from the passive exercise equipment 1 of the embodiment 2 in that the first foot support 2, at a side of a foot other than a pivoting foot of a user, reciprocated in a front-back direction in a horizontal plane is plantarflexed. A posture of the foot support 2 of which upper face is horizontal is hereinafter referred to as a basic posture. A posture of the foot support 2 that a user's toe side is turned downward from the basic posture is hereinafter referred to as a plantarflexion posture.

In the embodiment, the drive unit 3 has a second turning mechanism for left foot configured to plantarflex the left foot support by motive energy distributed through the power distribution unit, and a second turning mechanism for right foot configured to plantarflex the right foot support by motive energy distributed through the power distribution unit. The second turning mechanisms are provided in place of the first turning mechanisms of FIG. 7 explained in the embodiment 2. Other configuration is the same as FIG. 7, and the second turning mechanisms are not shown.

The second turning mechanisms can be easily realized by using the reciprocating mechanisms 33 and 34. That is, as shown in FIG. 11, the rails 23 for regulating each foot support's (2) moving path have inclined surfaces 26 at upper faces of their front-ends. The inclined surfaces 26 are formed to be lower toward their front-end sides, and are more declined as the foot supports 2 move forward from the reference positions.

Therefore, if a drive force of the motor 30 is transmitted to each frame 25 of the foot supports 2 through the power transmission part 31, each foot support 2 changes to a plantarflexion posture while moving forward along with a corresponding frame 25, and then returns to the basic posture while moving backward along with the frame 25. In this configuration, the crank connecting rods 39 coupled to the back-ends of the frames 25 are inclined with respect to a horizontal plane when the foot supports 2 are plantarflexed. Therefore, adjustable joint configurations such as ball joints or the like are used for joined portions of first and second pins 37 and 38 to both ends of a crank connecting rod 39.

While the right foot support 22 as the first foot support 2 moves one back-and-forth in a front-back direction, the right foot support 22 is turned through the second turning mechanism for right foot to change from the basic posture to the plantar flexion posture, and is then turned in an inverse direction to return to the basic posture. On the other hand, while the left foot support 21 as the first foot support 2 moves one back-and-forth in a front-back direction, the left foot support 21 is turned through the second turning mechanism for left foot to change from the basic posture to the plantarflexion posture, and is then turned in an inverse direction to return to the basic posture.

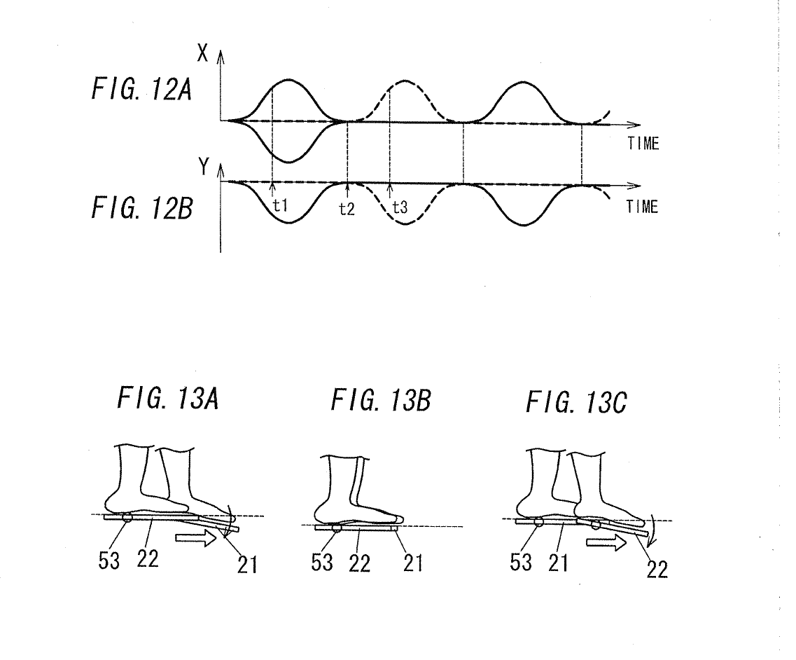

That is, a position and posture of each foot support 2 driven with the drive unit 3 periodically change as shown in FIGS. 12 and 13. In FIG. 12, the abscissa axis is a temporal axis. In FIG. 12A, the ordinate axis represents a distance X in a front direction from a reference position (X=0) of each foot support 2. In FIG. 12B, the ordinate axis represents a distance Y in an upper direction from a basic posture (Y=0) of each foot support's (2) front-end. The solid and dash lines represent movement of the left and right foot supports 21 and 22, respectively.

That is, the drive unit 3 first moves the left foot support 21 from the reference position to the predetermined position ahead of the reference position with the right foot support 22 restrained at the reference position, while turning the left foot support 21 in a direction that a user's toe side is turned downward. Accordingly, at time point t1 of FIG. 12, as shown in FIG. 13A, the left foot support 21 moves more forward than the right foot support 22, while the left foot support 21 is in the plantarflexion posture. If the left foot support 21 moves to the front-end of the movable scope (the predetermined position), the drive unit 3 moves the left foot support 21 backward to return it to the reference position, while turning the left foot support 21 to return it to the basic posture. Therefore, at time point t2 of FIG. 12, the positions of the left and right foot supports 21 and 22 in a front-back direction are accorded as shown in FIG. 13B, and the foot supports 2 become in the basic posture.

If the left foot support 21 returns to the reference position, the drive unit 3 next moves the right foot support 22 from the reference position to the predetermined position ahead of the reference position with the left foot support 21 restrained at the reference position, while turning the right foot support 22 in a direction that a user's toe side is turned downward. Accordingly, at time point t3 of FIG. 12, as shown in FIG. 13C, the right foot support 22 moves more forward than the left foot support 21, while the right foot support 22 is in the dorsiflexion posture. If the right foot support 22 moves to the front-end of the movable scope (the predetermined position), the drive unit 3 moves the right foot support 22 backward to return it to the reference position, while turning the right foot support 22 to return it to the basic posture.

As presented above, in the passive exercise equipment 1 of the embodiment, a user can turn upward and downward the toe of the foot other than a pivoting foot of the user, so that the ankle joint of the foot other than the pivoting foot can be plantarflexed. Thus, turning a foot support 2 to plantarflex the ankle joint induces exercise of muscle groups of user's legs and lower back by reflex of user's nerve system for maintaining balance in order to avoid falling.

If the foot support of the foot side other than a user's pivoting foot (i.e., the first foot support) becomes in a plantarflexion posture, a user receives a force by which the heel of the foot side other than the pivoting foot is pushed up with the foot support 2 and then maintains the user's posture in the teeth of the force, thereby contracting a muscle group of a user's shank (anterior tibial muscle and the like). Therefore, the muscle group of the shank is in a state similar to that at a heel contact (heel landing) timing during a shift from a swing phase to a contact phase in walking, and receives a stimulus similar to that in actual walking.

The embodiment shows that each second turning mechanism plantarflexes the first foot support 2, but may be configured to dorsiflex the first foot support 2. In this case, the rails 23 have inclined surfaces 26, at upper faces of their front-ends, which are higher toward their front-end sides.

As another example, the embodiment is further provided with a configuration for dorsiflexing a foot support of a user's pivoting foot side (i.e. the second foot support) like the embodiment 2. In this case, the second foot support 2 is dorsiflexed through a first turning mechanism 51, 52, and the first foot support 2 is plantarflexed through a second turning mechanism.

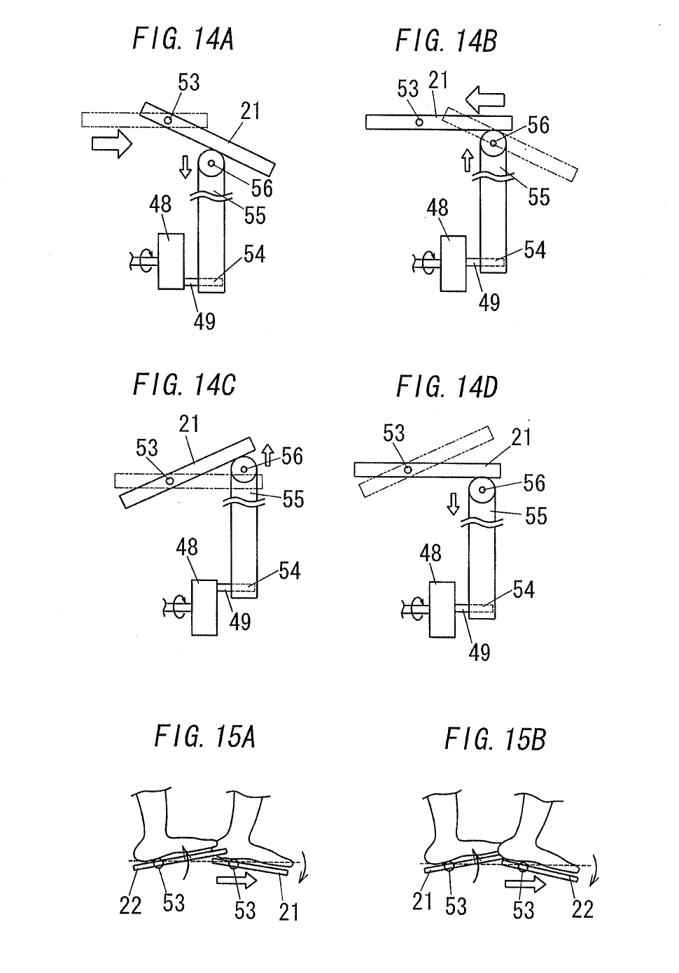

Specifically, in addition to the first turning mechanisms 51 and 52 of the embodiment 2 as fundamental, a positional relation between a cam 55 and a foot support 2 is set so that the foot support 2 is in the basic posture with a cam plate 55 positioned at the middle of the movable scope as shown in FIG. 14. FIG. 14 shows phased motion aspects of the foot support 2, and each dashed line shows a position of its own previous step's foot support 2.

Therefore, when the cam plate 55 is positioned at the middle of the movable scope, the foot support 2 is supported by the cam plate 55 to become approximately horizontal, namely the basic posture. From this state, the cam plate 55 moves upward, and the foot support 2 is then turned in a direction that a user's toe side is turned upward to be in dorsiflexion posture. To the contrary, the cam plate 55 moves downward, and the foot support 2 is then turned in a direction that a user's toe side is turned downward to be in plantarflexion posture. The timing for moving the cam plate 55 up and down is set through a mechanism formed of half-toothed wheels, or cams, electromagnetic clutches or the like in the embodiments 1, 2, in concert with the timing that each foot support 2 reciprocates in a front-back direction through the reciprocating mechanisms 33 and 34.

Thereby, a state that the left foot support 21 is in front and the left and right foot supports 21 are plantarflexed and dorsiflexed, respectively, as shown in FIG. 15A, and a state that the right foot support 22 is in front and the left and right foot supports 21 are dorsiflexed and plantarflexed, respectively, as shown in FIG. 15B are alternately repeated.

The second and first foot supports 2 and 2 may be plantarflexed and dorsiflexed, respectively by shifting the timing for moving the cam plate 55 up and down.

Thus, by plantarflexing and dorsiflexing the foot support 2 of a user's pivoting foot side and the foot support 2 of the user's foot side other than the pivoting foot, the passive exercise equipment 1 can give a stimulus similar to that in actual walking to user's each muscle group in comparison with only any one of the foot supports 2 being plantarflexed and dorsiflexed.

Other configurations and functions are the same as those of the embodiment 2.

In other words, in the aforementioned configuration A or B, the drive unit 3 is configured to turn the first foot support so that the first foot is plantarflexed or dorsiflexed while the first foot support (21 or 22) is reciprocated between the reference and predetermined positions defined for the first foot support, through a reciprocating mechanism (33 or 34). The drive unit 3 is also configured to turn the second foot support so that the second foot is plantarflexed or dorsiflexed while the second foot support (22 or 21) is reciprocated between the reference and predetermined positions defined for the second foot support, through a reciprocating mechanism.

Each of the embodiments shows a configuration that the left and right foot supports 21 and 22 are alternately reciprocated, but the passive exercise equipment 1 of the present invention is not limited this configuration. Only any one foot support 2 may be configured to be reciprocated. Thus, in the configuration that only one foot of a user is reciprocated, the user can perform exercise one foot by one foot, thereby especially working for rehabilitation for injury to only one lower extremity or the like.

In the configuration that only any one of the foot supports 2 is moved and the other is neither plantarflexed nor dorsiflexed, it is possible to remove one of the foot supports 2 as a component of the passive exercise equipment 1. In this case, it is desirable that a mark for showing a foot's position should be put on a floor or a housing of the passive exercise equipment 1 so that a user can recognize a position of a user's foot other than the foot to be rested on the foot support 2.

Although the present invention has been described with reference to certain preferred embodiments, numerous modifications and variations can be made by those skilled in the art without departing from the true spirit and scope of this invention, namely claims.

1. A passive exercise equipment, comprising:
a first foot support on which a foot of a user is rested; and
a drive unit configured to drive the first foot support,
wherein the drive unit comprises a reciprocating mechanism configured to reciprocate the first foot support between a reference position and a predetermined position behind or ahead of the reference position.

2. The passive exercise equipment of claim 1, comprising, in addition to said first foot support on which a first foot of the user is rested, a second foot support on which a second foot of the user is rested,
wherein the drive unit is configured:
to drive the first and second foot supports so as to keep the second foot support at the reference position defined for the second foot support while reciprocating the first foot support, through the reciprocating mechanism, between the reference and predetermined positions defined for the first foot support; and also
to drive the first and second foot supports so as to keep the first foot support at the reference position defined for the first foot support while reciprocating the second foot support, through the reciprocating mechanism, between the reference and predetermined positions defined for the second foot support.

3. The passive exercise equipment of claim 2, wherein the drive unit is configured:
to turn the second foot support so as to plantarflex or dorsiflex the second foot while keeping the second foot support at the reference position defined for the second foot support; and also
to turn the first foot support so as to plantarflex or dorsiflex the first foot while keeping the first foot support at the reference position defined for the first foot support.

4. The passive exercise equipment of claim 2, wherein the drive unit is configured:
to turn the first foot support so as to plantarflex or dorsiflex the first foot while reciprocating the first foot support, through the reciprocating mechanism, between the reference and predetermined positions defined for the first foot support; and also
to turn the second foot support so as to plantarflex or dorsiflex the second foot while reciprocating the second foot support, through the reciprocating mechanism, between the reference and predetermined positions defined for the second foot support.

5. The passive exercise equipment of claim 2,
wherein the drive unit is configured to drive the first and second foot supports so as to reciprocate the user's first and second feet in a front-back direction of the user through the reciprocating mechanism, respectively,
wherein each reference position of the first and second foot supports is a back-end of its own reciprocation path, and
wherein each predetermined position of the first and second foot supports is a front-end of its own reciprocation path.

6. The passive exercise equipment of claim 2,
wherein the drive unit is configured to drive the first and second foot supports so as to reciprocate the user's first and second feet in a front-back direction of the user through the reciprocating mechanism, respectively,
wherein each reference position of the first and second foot supports is a front-end of its own reciprocation path, and
wherein each predetermined position of the first and second foot supports is a back-end of its own reciprocation path.

7. The passive exercise equipment of claim 1, wherein a position of the first foot support, when the user takes a posture in which positions in a front-back direction of the user's feet are aligned, is defined as the reference position.

8. The passive exercise equipment of claim 7,
wherein the drive unit comprises a first turning mechanism configured to turn the first foot support around a turning axis along a horizontal plane, and
wherein the first turning mechanism is configured, during one back-and-forth motion of the first foot support between the reference and predetermined positions,
to turn the first foot support from a basic posture in which an upper face of the first foot support is horizontal to a plantarflexion or dorsiflexion posture in which a side of a user's toe is turned downward or upward, respectively, and then
to return it to the basic posture.

9. The passive exercise equipment of claim 4,
wherein the drive unit comprises a first turning mechanism configured to turn the first foot support around a turning axis along a horizontal plane, and
wherein the first turning mechanism is configured, during one back-and-forth motion of the first foot support between the reference and predetermined positions,
to turn the first foot support from a basic posture in which an upper face of the first foot support is horizontal to a plantarflexion or dorsiflexion posture in which a side of a user's toe is turned downward or upward, respectively, and then
to return it to the basic posture.

10. The passive exercise equipment of claim 7, comprising a second foot support on which a user's foot other than foot rested on the first foot support is rested, said second foot support being driven through the drive unit.

11. The passive exercise equipment of claim 10,
wherein the drive unit is configured to switch between a first state and a second state whenever the first foot support returns to the reference position after one back-and-forth motion,
wherein in the first state, one of the foot support on which the user's right foot is rested and the foot support on which the user's left foot is rested is treated as the first foot support, while the other is treated as the second support, and
wherein in the second state, the first foot support and the second foot support are interchanged from the first state between the foot support on which the right foot is rested and the foot support on which the left foot is rested.

12. The passive exercise equipment of claim 11,
wherein the drive unit is configured, while the reciprocating mechanism reciprocates the first foot support,
to restrain a position of the second foot support in a horizontal plane to a position that the user takes a posture in which positions in a front-back direction of the user's feet are aligned when the first foot support is at the reference position.

13. The passive exercise equipment of claim 2,
wherein the drive unit is configured, while the reciprocating mechanism reciprocates the first foot support,
to restrain a position of the second foot support in a horizontal plane to a position that the user takes a posture in which positions in a front-back direction of the user's feet are aligned when the first foot support is at the reference position.

14. The passive exercise equipment of claim 12,
wherein the drive unit comprises a second turning mechanism configured to turn the second foot support around a turning axis along a horizontal plane, and
wherein the second turning mechanism is configured, during one back-and-forth motion of the first foot support between the reference and predetermined positions,
to turn the second foot support from a basic posture in which an upper face of the second foot support is horizontal to a dorsiflexion or plantarflexion posture in which a side of a user's toe is turned upward or downward, respectively, and then
to return it to the basic posture.

15. The passive exercise equipment of claim 3, wherein the drive unit is configured:
to turn the first foot support so as to plantarflex or dorsiflex the first foot while reciprocating the first foot support, through the reciprocating mechanism, between the reference and predetermined positions defined for the first foot support; and also
to turn the second foot support so as to plantarflex or dorsiflex the second foot while reciprocating the second foot support, through the reciprocating mechanism, between the reference and predetermined positions defined for the second foot support.

16. The passive exercise equipment of claim 15,
wherein the drive unit comprises a first turning mechanism configured to turn the first foot support around a turning axis along a horizontal plane, and
wherein the first turning mechanism is configured, during one back-and-forth motion of the first foot support between the reference and predetermined positions,
to turn the first foot support from a basic posture in which an upper face of the first foot support is horizontal to a plantarflexion or dorsiflexion posture in which a side of a user's toe is turned downward or upward, respectively, and then
to return it to the basic posture.

17. The passive exercise equipment of claim 8, comprising a second foot support on which a user's foot other than foot rested on the first foot support is rested, said second foot support being driven through the drive unit.

18. The passive exercise equipment of claim 17,
wherein the drive unit is configured to switch between a first state and a second state whenever the first foot support returns to the reference position after one back-and-forth motion,
wherein in the first state, one of the foot support on which the user's right foot is rested and the foot support on which the user's left foot is rested is treated as the first foot support, while the other is treated as the second support, and
wherein in the second state, the first foot support and the second foot support are interchanged from the first state between the foot support on which the right foot is rested and the foot support on which the left foot is rested.

19. The passive exercise equipment of claim 18,
wherein the drive unit is configured, while the reciprocating mechanism reciprocates the first foot support,
to restrain a position of the second foot support in a horizontal plane to a position that the user takes a posture in which positions in a front-back direction of the user's feet are aligned when the first foot support is at the reference position.

20. The passive exercise equipment of claim 13,
wherein the drive unit comprises a second turning mechanism configured to turn the second foot support around a turning axis along a horizontal plane, and
wherein the second turning mechanism is configured, during one back-and-forth motion of the first foot support between the reference and predetermined positions,
to turn the second foot support from a basic posture in which an upper face of the second foot support is horizontal to a dorsiflexion or plantarflexion posture in which a side of a user's toe is turned upward or downward, respectively, and then
to return it to the basic posture.
